(19) United States
(12) Patent Application Publication
(10) Pub. No.: US 2015/0078922 A1
(43) Pub. Date: Mar. 19, 2015

(54) HIGH PRESSURE PUMP

(71) Applicant: DENSO CORPORATION, Kariya-city (JP)

(72) Inventors: Shinobu OIKAWA, Kariya-city (JP); Masatoshi KUROYANAGI, Kariya-city (JP)

(21) Appl. No.: 14/466,234

(22) Filed: Aug. 22, 2014

(30) Foreign Application Priority Data
Sep. 13, 2013 (JP) 2013-190474

(51) Int. Cl. F04B 49/22; F04B 7/02; F04B 17/05; F02M 59/02

(52) U.S. Cl. CPC F04B 49/22; F02M 59/02; F04B 7/02; F04B 17/05
USPC 417/213

(57) ABSTRACT

A high pressure pump includes a pump body, a pressurizing chamber, a fuel passage, a union, a seat member, a relief valve seat, a relief valve, a discharge valve seat, a discharge valve, a spring and a spring holder. The union has an inner threaded portion and a step portion formed on an inner wall of the union. The seat member includes a relief passage that extends through the seat member in an axial direction of the seat member and a discharge path that is not in fluid communication with the relief passage. The one opening of the relief passage is closer to the pressurizing chamber than an other opening of the relief passage is to the pressurizing chamber. The one opening of the discharge path is further from the pressurizing chamber than an other opening of the discharge path is from the pressurizing chamber. The seat member is pressed toward the step portion when the spring holder is fastened to the union by engaging the inner threaded portion with the outer threaded portion.

### CROSS REFERENCE TO RELATED APPLICATION

This application is based on and incorporates herein by reference Japanese Patent Application No. 2013-190474 filed on Sep. 13, 2013.

### TECHNICAL FIELD

The present disclosure relates to a high pressure pump.

### BACKGROUND

A high pressure pump for pressurizing fuel by reciprocal movement of a plunger has been conventionally known. Such a high pressure pump may have a pump body and a pressurizing chamber defined inside the pump body to pressure fuel inside the pressurizing chamber. The fuel pressured within the pressurizing chamber is discharged to a fuel rail of an internal combustion engine through a discharge passage. Further, the high pressure pump may include a relief passage for returning the fuel in the fuel rail to the pressurizing chamber when fuel pressure inside the fuel rail is greater than a specified value.

For example, a pressure pump disclosed in a patent document (JP 2013-50072 A) has a cylindrical union attached to a fuel passage of a pump body and a seat member provided inside the cylindrical union. The seat member includes a main body formed with a discharge passage and a relief passage, a cylindrical portion extending from an outer edge of the main body toward the pressurizing chamber, and a flange annually extending in an outer radial direction from one end of the cylindrical portion that is close to the pressurizing chamber. The flange is interposed between one end surface of the union, which is close to the pressurizing chamber, and a step portion formed on an inner surface of the fuel passage of the pump body. Thus, the seat member is fixed inside the union.

In the high pressure pump of the patent document, a relief valve seat is formed on an opening edge of the relief passage, and a relief valve seats on and separates from the relief valve seat. The relief valve seat is surrounded by the cylindrical portion and positioned deeply inside the cylindrical portion, which may cause a configuration of the seat member to be complicated and make processing of the relief valve seat difficult. When processing accuracy of the relief valve seat is decreased and stability on sitting of the relief valve is deteriorated, fuel discharged from the discharge passage is returned to the pressurizing chamber through the relief passage, and thus a fuel discharge amount from the pressure pump may be decreased.

### SUMMARY

It is an objective of the present disclosure to provide a high pressure pump having a simple configuration.

In an aspect of the present disclosure, a high pressure pump includes a pump body, a pressurizing chamber defined inside of the pump body and pressurizing fuel, a fuel passage positioned inside of the pump body and communicating with the pressurizing chamber, a union having a cylindrical shape and fixed to an inner wall of the fuel passage, a seat member disposed inside of the union, a relief valve seat disposed on the seat member at one opening of the relief passage, a discharge valve seat provided on the seat member at one opening of the discharge path, a discharge valve seating on and separating from the discharge valve seat, a spring biasing the relief valve toward the relief valve seat, and a spring holder having an outer threaded portion that engages the inner threaded portion of the union. The union has an inner threaded portion and a step portion formed on an inner wall of the union. The seat member includes a relief passage that extends through the seat member in an axial direction of the seat member and a discharge path that is not in fluid communication with the relief passage. The one opening of the relief passage is closer to the pressurizing chamber than an other opening of the relief passage is to the pressurizing chamber. A relief valve seats on and separates from the relief valve seat.

The one opening of the discharge path is further from the pressurizing chamber than an other opening of the discharge path is from the pressurizing chamber. The seat member is pressed toward the step portion when the spring holder is fastened to the union by engaging the inner threaded portion with the outer threaded portion.

According to the aspect of the present disclosure, the seat member is interposed between the step portion and the spring holder and fixed to the inner wall of the union. Thus, the seat member need not include the cylindrical portion and the flange as describe above, whereby simplifying the configuration of the seat member. The seat member has easy processing for the relief valve seat, and processing accuracy of the relief valve seat can be increased. As a result, the high pressure pump has high stability on sitting of the relief valve, and thus the relief passage can be surely closed.

Further, a cross section of a fuel passage of the spring holder can be made large by omitting the cylindrical portion and the flange as described above. Thus, the pressure loss of fuel flowing through the fuel passage can be reduced and a fuel discharge amount from the high pressure pump can be increased.

### BRIEF DESCRIPTION OF THE DRAWINGS

The disclosure, together with additional objectives, features and advantages thereof, will be best understood from the following description, the appended claims and the accompanying drawings, in which:

FIG. 1 is a configuration diagram of a fuel supply system including a high pressure pump according to a first embodiment of the present disclosure;

FIG. 2 is a cross-sectional view of the high pressure pump according to the first embodiment of the present disclosure;

FIG. 3 is a cross-sectional view of a fuel discharge passage portion of the high pressure pump according to the first embodiment of the present disclosure;

FIG. 4 is a diagram viewed from the direction IV in FIG. 3;

FIG. 5 is a cross-sectional view taken along the line V-V in FIG. 3;

FIG. 6 is a cross-sectional view taken along the line VI-VI in FIG. 3;

FIG. 7 is a cross-section view of the fuel discharge passage portion when the discharge valve is closed according to the first embodiment;

FIG. 8 is a cross-sectional view of the fuel discharge passage portion when a relief valve is opened according to the first embodiment;

FIG. 9 is a cross-sectional view of a fuel discharge passage portion according to a second embodiment of the present disclosure;

FIG. 10 is a diagram viewed from the direction X in FIG. 9; and

FIG. 11 is a cross-sectional view taken along the line XI-XI in FIG. 9.

### DETAILED DESCRIPTION

A plurality of embodiments of the present disclosure will be described hereinafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

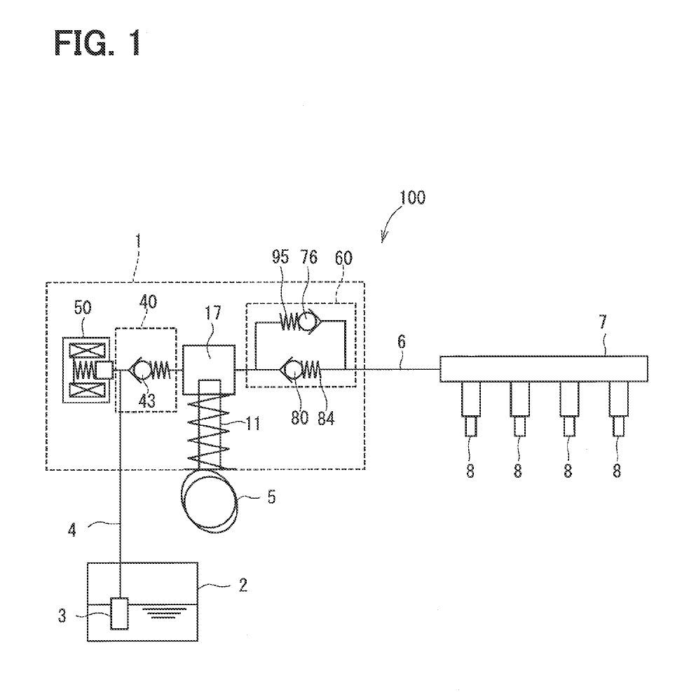

The first embodiment of the present disclosure will be described below with reference to FIGS. 1 to 8. A high pressure pump 1 of the present embodiment is installed to a fuel supply system 100 of an internal combustion engine (hereinafter “engine”) as shown in FIG. 1. The fuel supply system 100 has a fuel tank 2 for storing fuel and a low pressure pump 3 pumping the fuel from the fuel tank 2. The pumped fuel is supplied to the high pressure pump 1 through a low pressure fuel passage 4. The high pressure pump 1 includes a plunger 11 varying a capacity of a pressurizing chamber 17. The plunger 11 reciprocates in an axial direction according to a cam profile of a cam shaft 5. As a result, the capacity of the pressurizing chamber 17 varies whereby suction of the fuel, a fuel amount adjustment and pressurizing of the fuel is executed. When biasing force against a discharge valve 80 by fuel pressure inside the pressurizing chamber 17 is greater than a sum of biasing force against the discharge valve 80 by fuel pressure inside a high pressure fuel pipe 6 downstream of the discharge valve 80 and biasing force by a spring 84, the discharge valve 80 is opened. The fuel inside the pressurizing chamber 17 is supplied to a fuel rail 7 through the high pressure fuel pipe 6. The high pressured fuel stored in the fuel rail 7 is injected into a cylinder (not shown) of the engine by an injector 8 connected to the fuel rail 7.

The high pressure pump 1 includes a relief valve 76. The relief valve 76 is opened when fuel pressure inside the fuel rail 7 reaches an abnormally high pressure that is greater than a permissible range because of, for example, failure in a suction valve 43 or the discharge valve 80 of the high pressure pump 1, or increase in a fuel temperature. When the relief valve 76 is opened, the fuel inside the fuel rail 7 is returned to the pressurizing chamber 17. Accordingly, damage to components of the fuel supply system 100 by the high pressured fuel can be prevented and fuel injection by the injector 8 can be secured.

Next, an entire configuration of the high pressure pump 1 will described below.

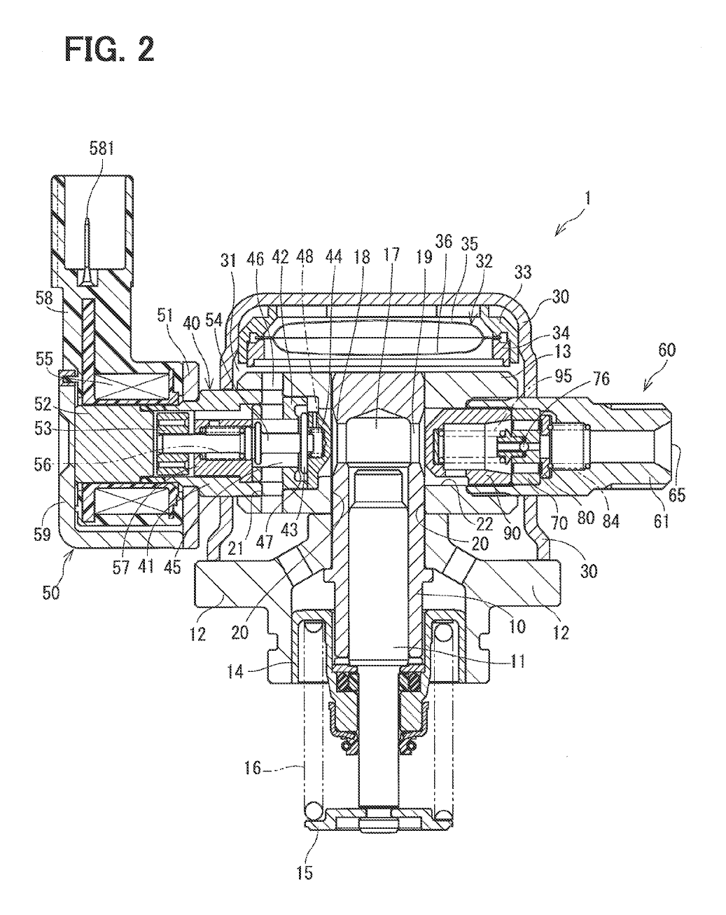

As shown in FIG. 2, the high pressure pump 1 includes a cylinder 10, the plunger 11, a lower housing 12, an upper housing 13, a cover 30, a fuel supply portion 40, an electromagnetic drive portion 50 and a fuel discharge passage portion 60.

The cylinder 10 and the upper housing 13 are one of examples of a “pump body”.

The cylinder 10 has a cylindrical shape and houses slidably the plunger 11 inside the cylinder 10. The lower housing 12 and the upper housing 13 are fixed to an outer wall of the cylinder 10. The lower housing 12 is attachable to a fitting hole (not shown) formed in the engine.

The cover 30 has a cylindrical shape with a bottom portion, and an opening end of the cover 30 is fixed to the lower housing 12 with liquid-tightness. A fuel chamber 31 is formed inside the cover 30 and fuel is fully filled inside the fuel chamber 31. The cover 30 is provided with a fuel inlet (not shown). Fuel pumped up from the fuel tank 2 is supplied to the fuel inlet and then is supplied to the fuel chamber 31 from the fuel inlet.

A pulsation damper 32 is provided inside the cover 30. The pulsation damper 32 has an outer edge interposed between an upper fixing member 33 and a lower fixing member 34 and is positioned between the upper housing 13 and the cover 30. The pulsation damper 32 has two diaphragms 35 and 36 that are overlapped each other and outer edges of the diaphragms 35 and 36 are connected to each other. The diaphragms 35 and 36 define a sealed space therebetween and air is sealed inside the sealed space at a specified pressure. The pulsation damper 32 reduces pressure pulsation of the fuel inside the fuel chamber 31 when the diaphragms 35 and 36 deform in a thickness direction with a center portion as a center point according to a variation of fuel pressure inside the fuel chamber 31.

A first spring 16 is provided between an oil sealing holder 14 fixed to the lower housing 12 and a spring seat 15 fixed to a lower end of the plunger 11. The first spring 16 biases the plunger 11 toward the cam shaft 5 of the engine. The plunger 11 reciprocates in the axial direction thereof according to the cam profile of the cam shaft 5.

An upper end of the plunger 11 and an inner wall of the cylinder 10 define the pressurizing chamber 17 therebetween. The cylinder 10 has an intake hole 18 open at one side of the pressurizing chamber 17 and a discharge hole 19 open at the other side of the pressurizing chamber 17.

The upper housing 13 has a substantially rectangular parallelepiped shape and a hole 20 is formed in a center of the upper housing 13. The cylinder 10 is inserted into the hole 20 with oil-tight. The upper housing 13 is fixed on the lower housing 12. The upper housing 13 has a fuel supply fitting hole 21 communicating with the intake hole 18 of the cylinder 10 and a fuel discharge fitting hole 22 communicating with the discharge hole 19 of the cylinder 10.

The fuel supply portion 40 includes a suction valve body 41, a suction valve seat member 42, a suction valve 43 and a stopper member 44.

The suction valve body 41 has a cylindrical shape and is fixed into the fuel supply fitting hole 21 of the upper housing 13.

The suction valve seat member 42 has a cylindrical shape and is housed inside the suction valve body 41. The suction valve seat member 42 has a suction chamber 45 formed therein. The suction chamber 45 communicates with the fuel chamber 31 outside of the upper housing 13 through a hole 46 formed in the upper housing 13. The suction valve seat member 42 has a valve seat 47 at an opening of the suction valve seat member 42 that is close to the pressurizing chamber of the suction chamber 45.

The suction valve 43 is positioned between the valve seat 47 and the pressurizing chamber 17 and seats on and separates from the valve seat 47. The suction valve 43 contacts on the stopper member 44 at an opening position.

A second spring 48 is provided between the stopper member 44 and the suction valve 43. The second spring 48 biases the suction valve 43 toward the valve seat 47.

The electromagnetic drive portion 50 includes a flange 51, a stator core 52, a movable core 53, a rod 54, a coil 55 and a third spring 56.

The flange 51 is fixed to an outer wall of the suction valve body 41. The movable core 53 is slidably housed inside the suction valve body 41. The rod 54 is fixed to a center portion of the movable core 53. A guide member 57 fixed inside the suction valve body 41 slidably supports the rod 54 in an axial direction of the rod 54. The third spring 56 biases the movable core 53 and the rod 54 toward the pressurizing chamber 17. The rod 54 biases the suction valve 43 toward the pressurizing chamber 17.

The stator core 52 is provided between the movable core 53 and the pressurizing chamber 17. The coil 55 is provided on outside of the suction valve body 41 in a radial direction of the suction valve body 41. When the coil 55 is energized through a terminal 581 of a connector 58, magnetic flux flows through a magnetic circuit formed by the movable core 53, the stator core 52, the flange 51 and a yoke 59. As a result, the movable core 53 and the rod 54 are magnetically attracted toward the stator core 52 against the biasing force by the third spring 56.

Whereas, the energization to the coil 55 is stopped, the magnetic flux flowing through the magnetic circuit dissipates, and thus the movable core 53 and the rod 54 are biased toward the pressurizing chamber 17 by the biasing force of the third spring 56.

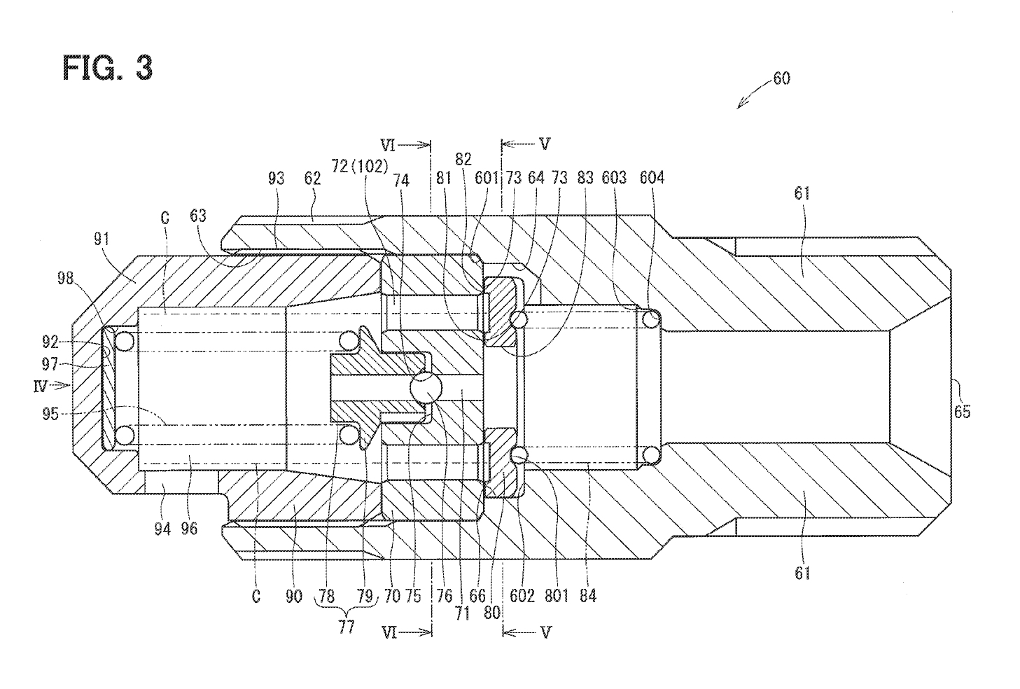

As shown in FIGS. 2 and 3, the fuel discharge passage portion 60 includes a union 61, a seat member 70, a discharge valve 80, a fourth spring 84, a relief valve 76, a spring holder 90 and a fifth spring 95.

The union 61 has a cylindrical shape and is fixed to an inner wall of the fuel discharge fitting hole 22 of the upper housing 13 by a screw 62. A passage formed inside the fuel discharge fitting hole 22 may be one of examples of a “fuel passage”.

The union 61 has an internal diameter decreasing in a step-by-step manner in a direction away from the pressurizing chamber 17. A first step portion 601, a second step portion 602, a third step portion 603, and a fourth step portion 604 are formed inside the union 61 in this order from the pressurizing chamber 17. The inner diameter of the union 61 is reduced at each step portion 601, 602, 603, 604. The union 61 includes an inner threaded portion 63 formed on an inner wall of the union 61 that is closer to the pressurizing chamber 17 than the first step portion 601 is to the pressurizing chamber 17.

The seat member 70 is provided inside the union 61. The seat member 70 has one end surface that faces in a direction away from the pressurizing chamber 17, and an outer edge of the one end surface entirely contacts the first step portion 601. In other words, the outer edge of the one end surface sealingly contacts the first step portion 601. The first step portion 601 may be one of examples of a “step portion”.

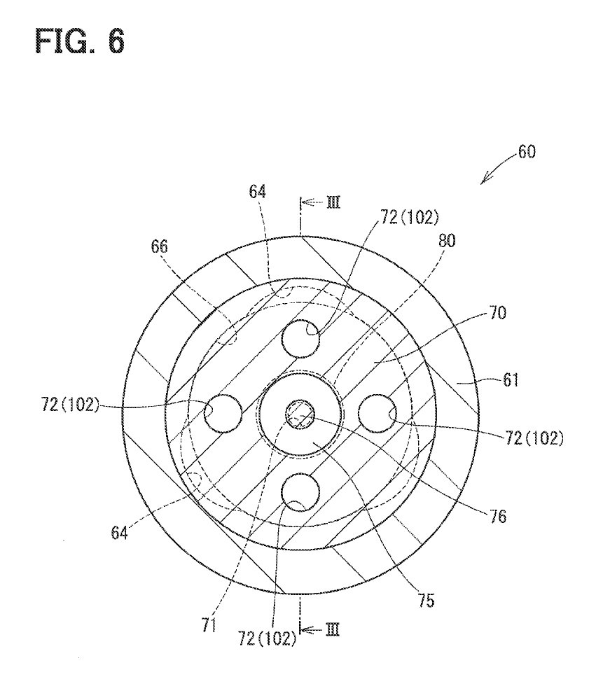

As shown in FIGS. 3 and 6, the seat member 70 includes a relief passage 71 and a discharge path 102, both of which pass through the seat member 70 in the axial direction of the seat member 70. The discharge path 102 includes a plurality of discharge passages 72 as shown in FIG. 6. The relief passage 71 is positioned at a center of the seat member 70, and the discharge passages 72 are positioned outward of the relief passage 71 in a radial direction of the seat member 70. The discharge passages 72 are not fluid communication with the relief passage 71.

A plurality of discharge valve seats 73 are formed on the one end surface of the seat member 70 at openings of the discharge passages 72 that are positioned on opposite side of the pressurizing chamber 17. In other words, each discharge valve seat 73 is formed on the seat member 70 at the one opening of the discharge passage 72 that is positioned further away from the pressurizing chamber 17 than the other opening of the discharge passage 72 is from the pressurizing chamber 17. Each discharge valve 80, which is positioned on opposite side of the seat member 70 with respect to the pressurizing chamber 17, seats on and separates from the corresponding discharge valve seat 73.

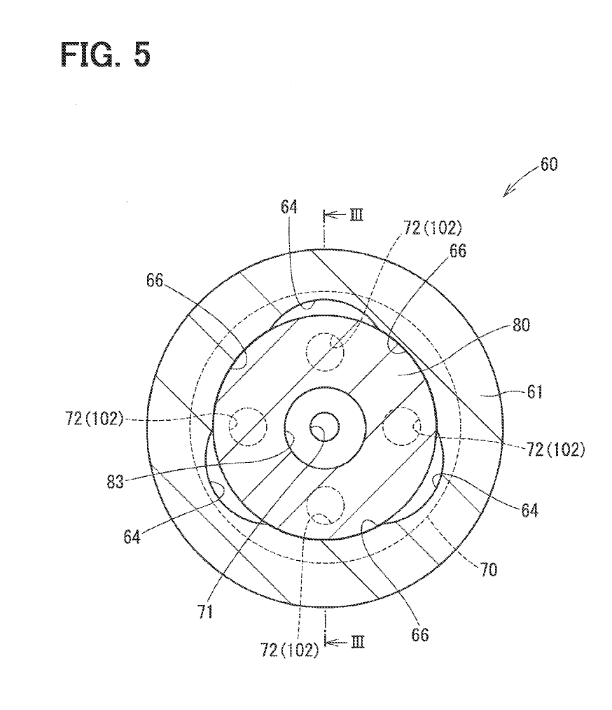

As shown in FIGS. 3 and 5, the discharge valve 80 is a multi-seat valve that has a first contact face 81 and a second contact face 82. The first contact face 81 contacts on a first end surface of the seat member 70 that is positioned inward of the discharge passages 72 in the radial direction of the seat member 70. The second contact face 82 contacts on a second end surface of the seat member 70 that is positioned outward of the discharge passages 72 in the radial direction of the seat member 70. The discharge valve 80 has an annular shape and a center hole 83 communicating with the relief passage 71 at a center position of the discharge valve 80.

The discharge valve 80 is prevented from moving in a direction away from the pressurizing chamber 17 by the second step portion 602 of the union 61. Thus, closing responsiveness of the discharge valve 80 can be improved. The second step portion 602 may be one of examples of a “stopper”.

The union 61 has a notched portion 64 outward of the discharge valve 80 in a radial direction of the union 61. The notched portion 64 allows the fuel to flow therethrough when the discharge valve 80 is opened. In the present embodiment, three of the notched portions 64 are provided on the inner wall of the union 61 in a circumferential direction of the union 61. A guide portion 66 is formed between the notched portions 64 to guide movement of the discharge valve 80 in the axial direction.

One end of the fourth spring 84 is fixed to a groove 801 annually formed on the discharge valve 80, and the other end of the second spring 84 is fixed to the fourth step portion 604 of the union 61. The fourth spring 84 biases the discharge valve 80 toward the discharge valve seat 73. The fourth spring 84 is prevented from moving in the radial direction of the union 61 by the groove 801 and the fourth step portion 604.

The third step portion 603 is positioned closer to the pressurizing chamber 17 than the fourth step portion 604 is to the pressurizing chamber 17. An inner diameter of the flow passage of the union 61 at the fourth spring 84 is greater than an outer diameter of the fourth spring 84. As a result, a space is defined between the fourth spring 84 and the union 61.

A relief valve seat 74 is formed on the seat member 70 at one opening of the relief passage 71 that is closer to the pressurizing chamber 17 than the other opening of the relief passage 71 is to the pressurizing chamber 17. More specifically, the seat member 70 has a recessed portion 75 recessed from the one end surface of the seat member 70 that is closer to the pressurizing chamber 17 than the other end surface of the seat member 70 and the relief valve seat 74 is formed on a bottom surface of the recessed portion 75.

The relief valve 76 has a spherical shape and is positioned on the one side of the seat member 70. The relief valve 76 seats on and separates from the relief valve seat 74. A relief valve holder 77 is positioned on the one side of the relief valve 76 so that the relief valve 76 is interposed between the relief valve holder 77 and the relief valve seat 74 of the seat member 70. The relief valve holder 77 has a shaft portion 78 and a spring hook portion 79. An outer surface of the shaft portion 78 is guided by an inner wall of the recessed portion 75 in the axial direction of the relief valve holder 77.

The spring holder 90 has a cylindrical shape and includes a cylindrical portion 91 and a bottom surface 92. The bottom surface 92 is formed on one end of the cylindrical portion 91 that is closer to the pressurizing chamber 17 than the other end of the cylindrical portion 91 is to the pressurizing chamber 17. An outer threaded portion 93 is formed on an outer wall of the cylindrical portion 91. The outer threaded portion 93 engages the inner threaded portion 63 formed on the inner wall of the union 61.

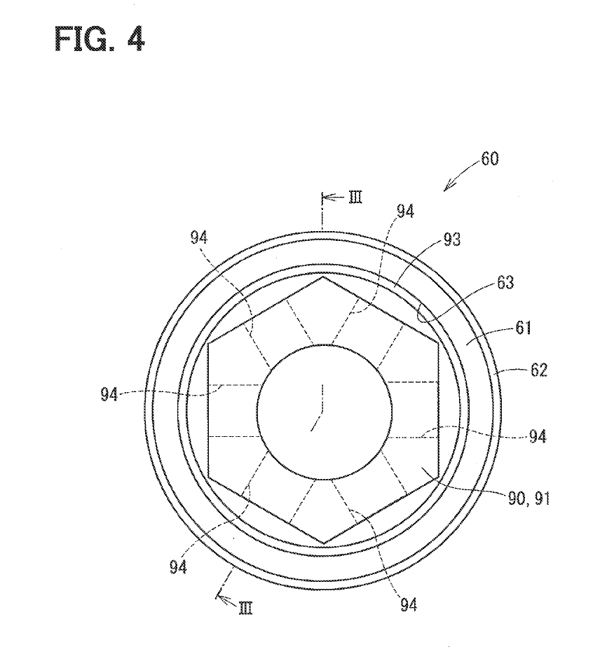

As shown in FIG. 4, the cylindrical portion 91 includes a non-threaded portion that is closer to the pressurizing chamber 17 than the outer threaded portion 93 is to the pressurizing chamber 17 and the non-threaded portion has an outer shape with a polygon (a hexagon in the present embodiment). That is, the outer shape of the non-threaded portion is in a non-circular shape. The non-threaded portion is used when fastening the spring holder 90 to the union 61. More specifically, a tool, such as a spanner or a box wrench is attached to the non-threaded portion, and then the spring holder 90 is rotated relative to the union 61 by rotating the tool around the axis of the spring holder 90 so that the outer threaded portion 93 engages the inner threaded portion 63. It should be noted that the shape of the spring holder 90 may be not necessarily limited to the polygon and any non-columnar shape may be used as far as the tool can be attached to the spring holder 90.

As shown in FIG. 3, when the outer threaded portion 93 of the spring holder 90 engages the inner threaded portion 63 of the union 61, the seat member 70 is pressed toward the first step portion 601 by fastening force between the outer threaded portion 93 and the inner threaded portion 63. In other words, the seat member 70 is pressed toward the first step portion 601 by engaging the inner threaded portion with the outer threaded portion. Accordingly, the seat member 70 is fixed between the union 61 and the spring holder 90.

As shown in FIGS. 3 and 6, the notched portion 64 is positioned inward of the outer wall of the seat member 70 in the radial direction of the seat member 70. Thus, an entire outer edge of one end surface on an opposite side of the seat member 70 with respect to the pressurizing chamber 17 contacts on the first step portion 601 with liquid-tight by the fastening force of the spring holder 90. Accordingly, fuel leakage at both end surfaces of the seat member 70 can be suppressed.

The cylindrical portion 91 has a fuel hole 94 on each surface of the non-threaded portion and each fuel hole 94 passes through the surface of the outer portion in a radial direction of the cylindrical portion 91. The fuel can flow between an inside and an outside of the spring holder 90 through the fuel holes 94.

As shown in FIG. 3, the fifth spring 95 is provided in an inner passage 96 formed inside the spring holder 90. One end of the fifth spring 95 is fixed to the bottom surface 92 of the spring holder 90 and the other end of the fifth spring 95 is fixed to the spring hook portion 79 of the relief valve holder 77. The fifth spring 95 biases the relief valve holder 77 and the relief valve 76 toward the relief valve seat 74. The fifth spring 95 of the present embodiment may be one of examples of a “spring”.

A shim 97 having a plate shape is provided between the bottom surface 92 of the spring holder 90 and the fifth spring 95. The variation of set load by the fifth spring 95 can be adjusted by setting the thickness of the shim 97.

The spring holder 90 includes a cavity 98 recessed from the bottom surface 92 toward the pressurizing chamber 17. The fifth spring 95 is prevented from moving in the radial direction of the spring holder 90 by an inner wall of the cavity 98.

The shaft portion 78 of the relief valve holder 77 protrudes toward the pressurizing chamber 17 from the spring hook portion 79. The other end of the fifth spring 95 is prevented from moving in the radial direction of the spring holder 90 by an outer surface of the shaft portion 78.

Accordingly, a space is defined between the inner wall of the spring holder 90 and the fifth spring 95.

A center axis C of the discharge passage 72 is positioned inside the inner passage 96. Further, the central axis C of the discharge passage 72 is positioned between the inner wall of the spring holder 90 and the fifth spring 95. In other words, the inner wall of the spring holder 90 is positioned radially outwardly with respect to the central axis C of the discharge passage 72 (i.e., discharge path 102). Thus, when the discharge valve 80 is opened, the fuel flowing into the inner passage 96 through the fuel hole 94 mainly flows through the space between the inner wall of the spring holder 90 and the fifth spring 95 and then smoothly flows into the discharge passage 72.

Next, an operation of the high pressure pump 1 will be described.

### (1) Suction Stroke

When the camshaft 5 is rotated and the plunger 11 is moved downward from a top dead position to a bottom dead position, the capacity of the pressurizing chamber 17 is increased and the pressure of the fuel is reduced. The discharge valve 80 seats on the discharge valve seat 73 to close the discharge passage 72.

Whereas, the suction valve 43 is moved, by differential pressure between the pressurizing chamber 17 and the suction chamber 45, toward the pressurizing chamber 17 against biasing force by the second spring 48 to open the suction valve body 41 (i.e., an open state).

When the suction valve 43 is open, the fuel inside the fuel chamber 31 flows through the suction chamber 45 and then flows into the pressurizing chamber 17.

It is noted that the relief valve 76 is opened only when fuel pressure inside the fuel rail 7 reaches the abnormally high pressure that is greater than a permissible range and otherwise seats on the relief valve seat 74 to close the relief passage 71.

### (2) Metering Stroke

When the camshaft 5 is rotated and the plunger 11 is moved upward from the bottom dead position to the top dead position, the capacity of the pressurizing chamber 17 is decreased. In this case, since the energization to the coil 55 is stopped until a given timing, the rod 54 biases the suction valve 43 toward the pressurizing chamber 17 by biasing force of the third spring 56. Thus, the suction valve 43 is maintained in the open state.

When the suction valve 43 is in the open state, communication between the pressurizing chamber 17 and the fuel chamber 31 is maintained. Therefore, the fuel at low pressure sucked into the pressurizing chamber 17 is returned to the fuel chamber 31 and then the pressure of the returned fuel inside the fuel chamber 31 is increased. Whereas, the fuel pressure inside the pressurizing chamber 17 does not increase.

When the energization to the coil 55 is started at the given timing in a middle of the movement of the plunger 11 from the bottom dead position toward the top dead position, the coil 55 generates magnetic field and a magnetic attraction is generated between the stator core 52 and the movable core 53 by the magnetic field. When the magnetic attraction is greater than a difference between the biasing force of the second spring 48 and the biasing force of the third spring 56, the movable core 53 moves toward the stator core 52. Therefore, the biasing force by the rod 54 against the suction valve 43 is released.

The suction valve 43 moves toward the valve seat 47 according to the movement of the rod 54 by the biasing force of the second spring 48 and the low pressure of the fuel discharged from the pressurizing chamber 17 to the suction chamber 45. And then, the suction valve 43 seats on the valve seat 47 to close the communication between the pressurizing chamber 17 and the suction chamber 45 (i.e., a closed state).

### (3) Discharge Stroke

While the suction valve 43 is closed, the fuel pressure inside the pressurizing chamber 17 increases as the plunger 11 moves upward. When the fuel pressure inside the pressurizing chamber 17 that acts the discharge valve 80 is greater than a sum of the fuel pressure at a fuel outlet 65 that acts the discharge valve 80 and the biasing force of the fourth spring 84, the discharge valve 80 is opened. Accordingly, the fuel pressurized inside the pressurizing chamber 17 is discharged from the fuel outlet 65.

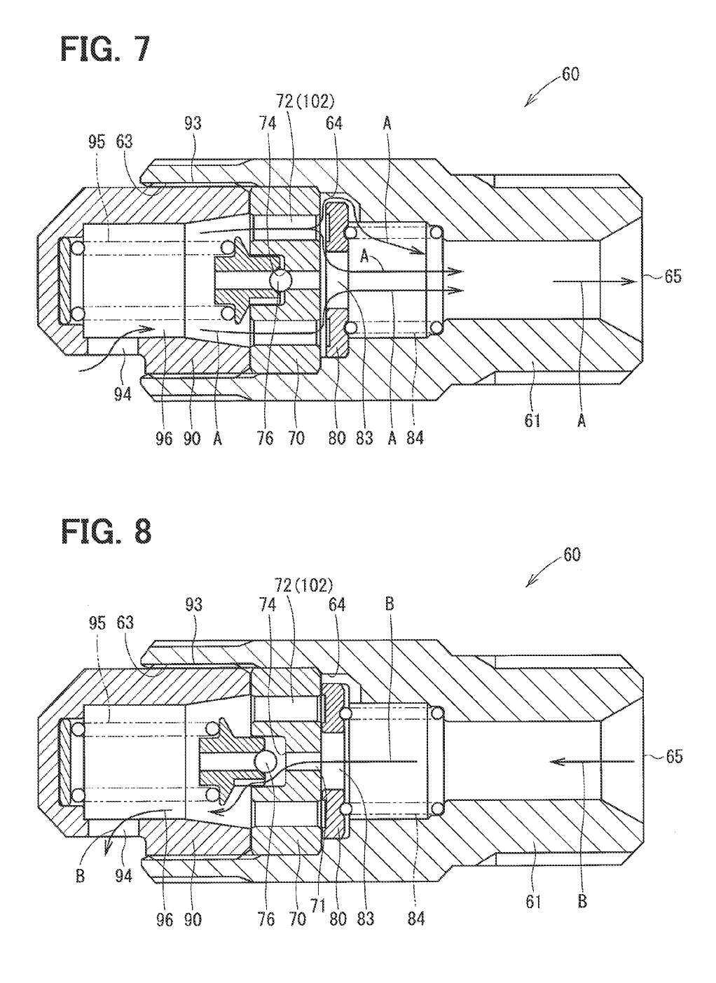

FIG. 7 shows a state in which the pressurized fuel is discharged through the fuel outlet 65. As indicated by an arrow A in FIG. 7, the fuel flows through the fuel hole 94 from the pressurizing chamber 17 and flows into the inner passage 96. And then, the fuel flows mainly through between the inner wall of the spring holder 90 and the fifth spring 95 and flows into the discharge passage 72. Eventually, the fuel is discharged from the fuel outlet 65 after flowing through the center hole 83 of the discharge valve 80 or the notched portion 64 of the union 61.

Since the center shaft C of the discharge passage 72 is positioned between the inner wall of the spring holder 90 and the fifth spring 95, the fuel can smoothly flow between the inner wall of the spring holder 90 and the fifth spring 95. Thus, pressure loss of the fuel flowing through the inner passage 96 is reduced, and thus the fuel discharge amount from the high pressure pump 1 can be increased.

Further, since the fuel mainly flows through between the inner wall of the spring holder 90 and the fifth spring 95, a fuel amount flowing inside the fifth spring 95 is reduced. Therefore, the fifth spring 95 can be suppressed to shake. As a result, the relief valve 76 stably seats on the relief valve seat 74, whereby preventing the fuel flowing back from a downstream side of the discharge valve 80.

The energization to the coil 55 is stopped in a middle of the discharge stroke. In this case, since the fuel pressure inside the pressurizing chamber 17 against the suction valve 43 is greater than the biasing force of the third spring 56, the suction valve 43 is maintained to be in the closed state.

The high pressure pump 1 pressurizes and discharges the fuel in a required amount by executing repeatedly the suction stroke, the metering stroke and the discharge stroke.

Next, a case where the pressure inside the fuel rail 7 reaches the abnormally high pressure beyond the permissible range will be described below. When the fuel pressure acting the relief valve 76 from a side of the fuel outlet 65 is greater than the sum of the fuel pressure acting the relief valve 76 from a side of the pressurizing chamber 17 and the biasing force of the fifth spring 95, the relief valve 76 is opened. As a result, the fuel inside the fuel rail 7 is returned to the pressurizing chamber 17.

FIG. 8 shows a state in which the fuel is returned to the pressurizing chamber 17. As indicated by an arrow B in FIG. 8, the fuel flows through the relief passage 71 from the fuel outlet 65 and flows into the inner passage 96. Then, the fuel flows mainly through between the inner wall of the spring holder 90 and the fifth spring 95 and flows toward the pressurizing chamber 17 through the fuel hole 94. At this time, since the fuel smoothly flows through between the inner wall of the spring holder 90 and the fifth spring 95, the pressure inside the fuel rail 7 can be reduced to within the permissible range in a short time.

Further, the amount of the fuel flowing through inside the fifth spring 95 can be reduced due to the main fuel flow between the inner wall of the spring holder 90 and the fifth spring 95. Thus, the fifth spring 95 can be suppressed to shake. As a result, when the fuel pressure inside the fuel rail 7 decreases to fall into the permissible range, the relief valve 76 can surely seat on the relief valve seat 74.

The high pressure pump 1 according to the present embodiment provides operation and effects as described below.

(1) In the first embodiment, the seat member 70 is pressed toward the first step portion 601 of the union 61 by the fastening force between the outer threaded portion 93 of the spring holder 90 and the inner threaded portion 63 of the union 61. That is, when the spring holder 90 is fastened to the union 61 by engaging the outer threaded portion 93 with the inner threaded portion 63, the seat member 70 is pressed toward the first step portion 601.

Therefore, the seat member 70 is interposed between the first step portion 601 and the spring holder 90 to be fixed inside the union 61 with liquid-tightness. Thus, another member for fixing the seat member 70 is not needed, whereby simplifying the configuration of the seat member 70. Accordingly, since processing for forming the relief valve seat 74 that is positioned close to the pressurizing chamber 17 is made easy, the processing accuracy of the relief valve seat 74 can be enhanced. As a result, the relief valve 76 can stably seat on the relief valve seat 74 and surely close the relief passage 71.

(2) In the first embodiment, the spring holder 90 has the portion with the polygonal shape that is positioned close to the pressurizing chamber 17.

Therefore, the outer threaded portion 93 of the spring holder 90 can surely engage the inner threaded portion 63 of the union 61 by attaching the tool to the outer portion.

(3) In the first embodiment, the outer edge of the end surface of the seat member 70 that faces in the direction away from the pressurizing chamber 17 entirely contacts the first step portion 601 with liquid-tightness by the fastening force between the spring holder 90 and the union 61. In other words, the outer edge of the one end surface sealingly contacts the first step portion 601 when the spring holder 90 is fastened to the union 61.

Thus, the fuel leakage at both end surfaces of the seat member 70 can be prevented with such a simple configuration.

(4) In the first embodiment, the inner wall of the spring holder 90 is positioned outward of the center axis C of the discharge passage 72 in the radial direction. That is, the center axis C is positioned inside inner passage 96 of the spring holder 90.

Therefore, the cross section of the inner passage 96 can made large in the radial direction. Thus, the pressure loss of the fuel flowing through the inner passage 96 can be reduced and the fuel flowing into the inner passage 96 through the fuel hole 94 can smoothly flow toward the discharge passage 72 of the seat member 70. Accordingly, the fuel discharge amount of the high pressure pump 1 can be increased.

(5) In the first embodiment, the center axis C of the discharge passage 72 is positioned between the inner wall of the spring holder 90 and the fifth spring 95.

Therefore, the fuel flowing into the inner passage 96 through the fuel hole 94 of the spring holder 90 flows through between the inner wall of the spring holder 90 and the fifth spring 95 and flows toward the discharge passage 72.

(6) In the first embodiment, the spring holder 90 has the cavity 98 on the bottom surface 92 and the cavity 98 prevents the fifth spring 95 from moving in the radial direction.

Therefore, since the movement of the fifth spring 95 toward the center axis C of the discharge passage 72 is prevented, the pressure loss of the fuel flowing through the inner passage 96 can be reduced.

(7) In the first embodiment, the discharge valve 80 is prevented from moving away from the pressurizing chamber 17 by the second step portion 602 formed on the inner wall of the union 61.

Hence, the second step portion 602 can serve a stopper for the discharge valve 80 with such a simple configuration.

(8) In the first embodiment, the discharge valve 80 has the center hole 83 at the center position of the discharge valve 80, whereby preventing the discharge valve 80 from closing the relief passage 71.

### Second Embodiment

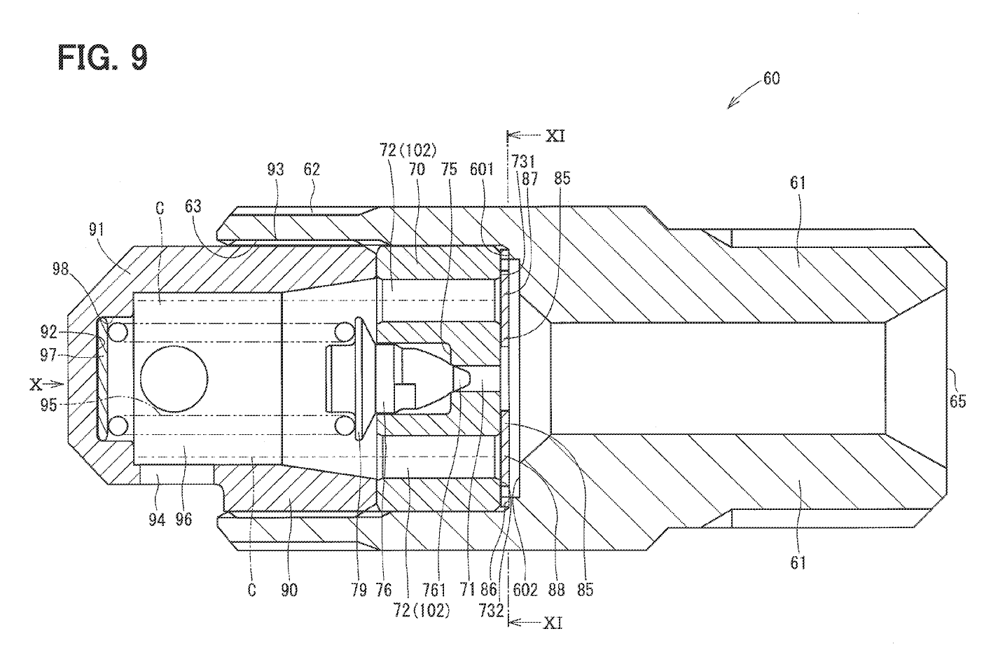

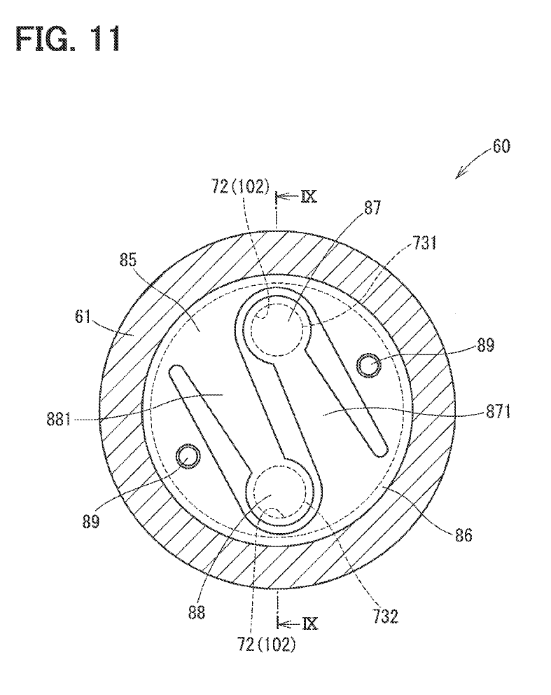

A fuel discharge passage portion 60 of a high pressure pump 1 of the second embodiment will be described below with reference to FIGS. 9 to 11.

In the second embodiment, a discharge valve 85 is positioned on an opposite side of a seat member 70 with respect to a pressurizing chamber 17 and has a plate shape. The discharge valve 85 includes an outer edge 86, a first discharge valve portion 87, a second discharge valve portion 88, a first spring portion 871 (leaf spring), a second spring portion 881 (leaf spring) and a positioning portion 89. It should be noted that, although the outer edge 86 and an inner portion inside the outer edge 86 are conceptually separated by a dashed line, the outer edge 86 and the inner portion are integrally formed.

The outer edge 86 of the discharge valve 85 is press-fitted between a first step portion 601 of a union 61 and the seat member 70. A spring holder 90 presses the seat member 70 and the discharge valve 85 toward the first step portion 601 of the union 61 by fastening force between the spring holder 90 and the union 61 when the spring holder 90 is fastened to the union 61.

The seat member 70 of the second embodiment has two discharge passages 72 that are opposite to each other across a relief passage 71, which is positioned at a center position of the seat member 70, in a radial direction of the seat member 70. The seat member 70 has one end surface positioned on an opposite side of the seat member 70 with respect to the pressurizing chamber 17 and the discharge passages 72 are open on the one end surface. A first discharge valve seat 731 and a second discharge valve seat 732 are formed on the one end surface of the seat member 70.

The first discharge valve portion 87 seats on and separates from the first discharge valve seat 731 and the second discharge valve portion 88 seats on and separates from the second discharge valve seat 732.

The first spring portion 871 extends toward the first discharge valve portion 87 from the outer edge 86 at a position adjacent to the second discharge valve portion 88 in a circumferential direction of the discharge valve 85 and is connected to the first discharge valve portion 87. The first spring portion 871 biases the first discharge valve portion 87 toward the first discharge valve seat 731.

The second spring portion 881 extends toward the second discharge valve seat 732 from the outer edge 86 at a position adjacent to the first discharge valve portion 87 in the circumferential direction of the discharge valve 85 and is connected to the second discharge valve portion 88. The second spring portion 881 biases the second discharge valve portion 88 toward the second discharge valve seat 732.

The first discharge valve portion 87 is opened when fuel pressure inside the pressurizing chamber 17 that acts the first discharge valve portion 87 is greater than a sum of fuel pressure at the fuel outlet 65 that acts the first discharge valve portion 87 and biasing force of the first spring portion 871. The second discharge valve portion 88 is the same as the first discharge valve portion 87. Therefore, high pressured fuel pressurized inside the pressurizing chamber 17 flows through the discharge passage 72 and is discharged through the fuel outlet 65.

The positioning portion 89 of the discharge valve 85 is a protrusion or a recessed portion and is fit into a recessed portion or a protrusion, both of which are not shown, formed on the seat member 70. Thus, the discharge valve 85 is locked in the circumferential direction and a radial direction of the discharge valve 85 by the positioning portion 89.

As shown in FIG. 9, the relief valve 76 of the second embodiment includes a tip end portion 761, which seats on and separates from the relief valve seat 74, and a spring hook portion 79. The tip end portion 761 and the spring hook portion 79 are formed integrally. Thus, the relief valve 76 of the second embodiment can be formed by fewer components than that of the first embodiment.

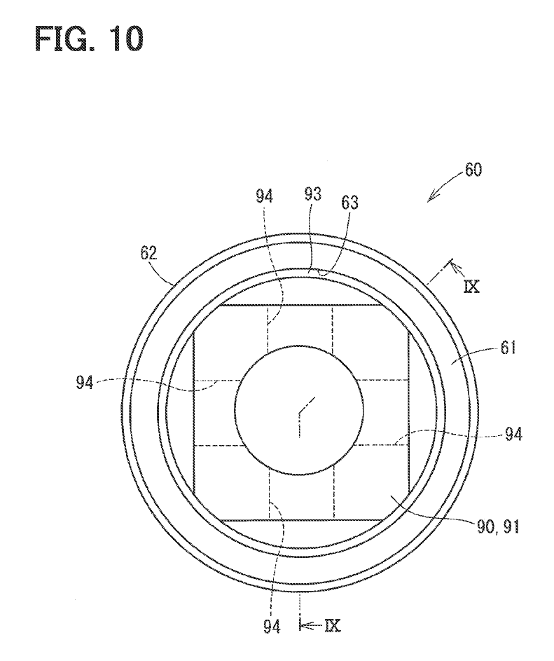

As shown in FIG. 10, the spring holder 90 of the second embodiment has a cylindrical portion 91. The cylindrical portion 91 has a non-threaded portion that is closer to the pressurizing chamber 17 than an outer threaded portion 93 is to the pressurizing chamber 17. The non-threaded portion of the cylindrical portion 91 has a substantially rectangular shape with four rounded corners. The spring holder 90 can be rotated around an axis of the spring holder 90 by rotating a tool that is attached to the non-threaded portion of the cylindrical portion 91, whereby fastening the outer threaded portion 93 of the spring holder 90 to an inner threaded portion 63 of the union 61.

According to the high pressure pump 1 of the second embodiment, operation and effects as described below can be attained in addition to the operation and the effects as described in the first embodiment.

(1) In the second embodiment, the discharge valve 85 has a plate shape and includes the outer edge 86, the spring portions 871 and 881 that respectively extend from the outer edge 86 toward the discharge valve seat 731 and 732, and the discharge valve portions 87 and 88 that are respectively connected to the spring portions 871 and 881.

Therefore, the configuration of the discharge valve 85 can be made simple. Further, the size of the discharge valve 85 can be made small.

(2) In the second embodiment, the first discharge valve portion 87, which is connected to the first spring portion 871 extending from the outer edge 86, opens and closes the first discharge valve seat 731. Furthermore, the second discharge valve portion 88, which is connected to the second spring portion 881 extending from the outer edge 86, opens and closes the second discharge valve seat 732. Accordingly, two discharge valve seats 731 and 732 are opened and closed by the single plate-like discharge valve 85 with a simple configuration.

### MODIFICATIONS

In the above-described embodiments, the seat member has the relief passage at the center position of the seat member and the plural discharge passages are positioned outward of the relief passage in the radial direction of the seat member. Alternatively, in a modification, a seat member may have a discharge passage at the center position of the seat member and a relief passage may be formed at a position outward of the discharge passage in a radial direction of the seat member.

The present disclosure is not necessarily limited to the above-described embodiments and the modification, and the embodiments may be combined each other. Further, other modifications may be applied to the embodiments within the scope of the gist of the present disclosure.

What is claimed is:

1. A high pressure pump comprising:
a pump body;
a pressurizing chamber defined inside of the pump body and pressurizing fuel;
a fuel passage positioned inside of the pump body and communicating with the pressurizing chamber;
a union having a cylindrical shape and fixed to an inner wall of the fuel passage, the union having an inner threaded portion and a step portion formed on an inner wall of the union;
a seat member disposed inside of the union, the seat member including a relief passage that extends through the seat member in an axial direction of the seat member and a discharge path that is not in fluid communication with the relief passage;
a relief valve seat disposed on the seat member at one opening of the relief passage, the one opening of the relief passage being closer to the pressurizing chamber than an other opening of the relief passage is to the pressurizing chamber;
a relief valve seating on and separating from the relief valve seat;
a discharge valve seat provided on the seat member at one opening of the discharge path, the one opening of the discharge path being further from the pressurizing chamber than an other opening of the discharge path is from the pressurizing chamber;
a discharge valve seating on and separating from the discharge valve seat;
a spring biasing the relief valve toward the relief valve seat; and
a spring holder having an outer threaded portion that engages the inner threaded portion of the union, wherein
the seat member is pressed toward the step portion when the spring holder is fastened to the union by engaging the inner threaded portion with the outer threaded portion.

2. The high pressure pump according to claim 1, wherein
the spring holder includes a non-threaded portion that is closer to the pressurizing chamber than the outer threaded portion is to the pressurizing chamber, the non-threaded portion having an outer surface with a non-circular shape.

3. The high pressure pump according to claim 1, wherein
the seat member includes an end surface that faces in a direction away from the pressurizing chamber, the end surface of the seat member sealingly contacting the step portion of the union when the spring holder is fastened to the union.

4. The high pressure pump according to claim 1, wherein
the spring holder includes a cylindrical portion that has the outer threaded portion positioned thereon,
the cylindrical portion includes an inner passage defined by an inner wall and a fuel hole passing through the inner wall, and
a center axis of the discharge path is positioned inside the inner passage.

5. The high pressure pump according to claim 1, wherein
the center axis of the discharge path is positioned between the inner wall of the spring holder and the spring.

6. The high pressure pump according to claim 1, wherein
the spring holder includes a cylindrical portion that has the outer threaded portion positioned thereon, a bottom surface formed on one end of the cylindrical portion that is closer to the pressurizing chamber than an other end of the cylindrical portion is to the pressurizing chamber, and a cavity formed on the bottom surface inside of the spring holder that prevents the spring from moving in a radial direction of the spring holder.

7. The high pressure pump according to claim 1, wherein
the union includes a stopper that prevents the discharge valve from moving in a direction away from the pressurizing chamber.

8. The high pressure pump according to claim 1, wherein
the relief passage passes through a center of the seat member in an axial direction of the seat member,
the discharge path includes a plurality of discharge passages that pass through the seat member in the axial direction of the seat member, and
the discharge valve has an annular shape and a center hole that is positioned at a center of the discharge valve and communicates with the relief passage.

9. The high pressure pump according to claim 1, wherein
the discharge valve includes
an outer edge press-fitted between the step portion of the union and the seat member,
a spring portion extending from the outer edge toward the discharge valve seat, and
a valve connected to an end of the spring portion and seating on and separating from the discharge valve seat, wherein
the discharge valve has a plate shape.

10. The high pressure pump according to claim 1, wherein
the seat member includes a first discharge valve seat and a second discharge valve seat, the first discharge valve seat positioned opposite to the second discharge valve seat across the relief passage formed at a center portion of the seat member, and
the discharge valve includes:
a first discharge valve portion seating on and separating from the first discharge valve seat;
a second discharge valve portion seating on and separating from the second discharge valve seat;
a first spring portion connected to the first discharge valve portion and extending toward the first discharge valve seat from an outer edge of the discharge valve at a position adjacent to the second discharge valve portion in a circumferential direction of the discharge valve; and
a second spring portion connected to the second discharge valve portion and extending toward the second discharge valve seat from the outer edge of the discharge valve at a position adjacent to the first discharge valve portion in the circumferential direction of the discharge valve.
